(19) United States
(12) Patent Application Publication
(10) Pub. No.: US 2023/0018163 A1
(43) Pub. Date: Jan. 19, 2023

(54) POLYESTER-BASED SOLID POLYMER COMPOSITE ELECTROLYTES FOR ENERGY STORAGE DEVICES

(71) Applicant: Trustees of Dartmouth College, Hanover, NH (US)

(72) Inventors: Edward Matios, Carson City, NV (US); Huan Wang, Hanover, NH (US); Weiyang Li, Hanover, NH (US)

(73) Assignee: Trustees of Dartmouth College, Hanover, NH (US)

(21) Appl. No.: 17/782,952

(22) PCT Filed: Dec. 9, 2020
(86) PCT No.: PCT/US2020/063909

§ 371 Date: Jun. 6, 2022

Related U.S. Application Data
(60) Provisional application No. 62/945,365, filed on Dec. 9, 2019.

(51) Int. Cl. H01M 10/056; H01M 10/054

(52) U.S. Cl. CPC H01M 10/056; H01M 10/054; H01M 2300/0071; H01M 2300/0082; H01M 2300/0091

(57) ABSTRACT

In an embodiment, the present disclosure pertains to a non-aqueous electrolyte. In some embodiments, the non-aqueous electrolyte includes a polymeric component and a ceramic component. The polymeric component includes a polyester-based polymer and a polyether-based polymer. The ceramic component includes inorganic materials. In an additional embodiment, the present disclosure pertains to an energy storage device including an anode, a cathode, and a non-aqueous electrolyte of the present disclosure. In a further embodiment, the present disclosure pertains to a method of making a non-aqueous electrolyte by mixing a polymeric component and a ceramic component of the present disclosure.

### CROSS-REFERENCE TO RELATED APPLICATIONS

This application claims priority to U.S. Provisional Patent Application No. 62/945,365, filed on Dec. 9, 2019. The entirety of the aforementioned application is incorporated herein by reference.

### BACKGROUND

Non-aqueous electrolytes, for example solid-state ceramic electrolytes, can have the benefit of high ionic conductivity. However, the viability of these non-aqueous electrolytes remains very implausible. Non-aqueous electrolytes have several major challenges, such as production scalability, manufacturability, having a rigid and non-flexible structure, having low throughput, being expensive, and having high interfacial impedance. Various embodiments of the present disclosure address the aforementioned limitations.

### SUMMARY

In an embodiment, the present disclosure pertains to a non-aqueous electrolyte. In some embodiments, the non-aqueous electrolyte includes a polymeric component and a ceramic component. In some embodiments, the polymeric component includes at least one of a polyester-based polymer, a polyether-based polymer or combinations thereof. In some embodiments, the ceramic component includes inorganic materials.

In an additional embodiment, the present disclosure pertains to an energy storage device including an anode, a cathode, and a non-aqueous electrolyte of the present disclosure. In a further embodiment, the present disclosure pertains to a method of making a non-aqueous electrolyte. In general, the method includes mixing a polymeric component and a ceramic component of the present disclosure. In some embodiments, the mixing occurs by solid-state mixing. In some embodiments, the method can further include a step of incorporating the non-aqueous electrolyte into an energy storage device.

### DESCRIPTION OF THE DRAWINGS

FIG. 1A depicts a non-aqueous electrolyte according to aspects of the present disclosure.

FIG. 1B depicts an energy storage device according to aspects of the present disclosure.

FIG. 1C illustrates a method of making a non-aqueous electrolyte according to aspects of the present disclosure.

FIG. 2 illustrates a schematic that shows the scientific mechanism that enables a novel and optimized solid polymer composite electrolyte proposed here through combining ceramic filler (sodium super ionic conductors (NASICON)) and amorphous polyester polymer (polypropylene carbonate (PPC) and polyethylene carbonate (PEC)) into polyether (polyethylene oxide (PEO)) host polymer to simultaneously increase the ionic conductivity, interfacial conductivity, electrochemical properties, thermal stability and mechanical strength. The discovery is that the polyester spontaneously reacts with Na metal anode through random chain scission by sodium (Na) metal to form an interfacial wetting agent that decreases the interfacial impedance (right).

FIG. 3 illustrates a process flow chart and preliminary data depicting the solid-state mixing method of the proposed solid polymer composite electrolyte, which demonstrated flexibility and thinness. The preliminary experimental data showcased the dramatically lower ionic resistance with the solid-state mixing method.

FIG. 4 illustrates electrochemical impedance spectrometry measurements that validate the superiority of low ionic resistance from the solid-state mixing method: the ionic resistances of 2000 ohms and 5000 ohms for solid-state mixed PPC+NASICON and PEO+NASICON, respectively. These numbers are substantial improvements from solution mixed PPC+NASICON (7000 ohm) and PEO+NASICON (22000 ohm).

FIG. 5 illustrates electrochemical impedance spectrometry tests that indicate the ionic conductivity of the solid polymer composite electrolyte synthesized by solid-state mixing with the optimized recipe is about 100 folds higher than that of solid polymer composite electrolyte made by conventional approach (top left). This superior ionic conductivity of the proposed solid polymer composite electrolyte remains true in various temperatures (right), and thus proved the next-level performance of the proposed solid polymer composite electrolyte at all conditions.

FIG. 6 illustrates electrochemical cycling performances of Na metal batteries (top left and top right) equipped with polyester polymer (i.e. PPC, PEC) alone without polyether polymer (i.e. PEO), and batteries that exhibited short-circuit due to the random chain scission by Na. Meanwhile, the electrochemical cycling performances of lithium metal batteries (bottom) with polyester polymer showed no short-circuit and therefore indicated that the polyester does not react with lithium.

FIG. 7 illustrates an in-depth experimental design to optimize the proposed solid polymer electrolyte by blending with the polyether polymer (i.e. PEO), polyester polymer (i.e. PPC, PEC) and ceramic filler (i.e. NASICON) to yield a chemically stable and high performance PEO−PPC−NASICON solid polymer composite electrolyte. Further developments with the proposed solid-state polymer composite electrolyte led to about 25 times higher ionic conductivity (0.12 mS/cm) than conventional state-of-the-art PEO solid polymer electrolyte (0.005 mS/cm).

FIG. 8 illustrates scanning electron microscope images showing individually that the PEO polymer, PPC polymer and NASICON ceramic fillers, as well as the blending of three ingredients with optimized ratio through solid-state mixing. The blended PEO+PPC+NASICON image exhibit exceptionally smooth and homogenous morphology, indicating that the solid-state mixing effectively yields excellent wrapping of polymers on ceramics.

FIG. 9 illustrates that X-ray diffraction patterns indicated the solid-state mixed PEO+PPC+NASICON solid polymer composite electrolyte displays significantly more amorphous phase compared to conventional PEO solid polymer electrolyte. This in turn provided significantly improved ionic conductivity as a result of amorphous region for faster ionic transport.

FIG. 10 illustrates differential scanning calorimetry data revealing that glass transition temperature (T_{g}) is effectively lower in the solid polymer composite electrolyte synthesized by solid-state mixing method, therefore yielding a much higher ionic conductivity as a result. Overall, the proposed solid polymer composite electrolyte PEO+PPC+NASICON showcases the lowest T_{g} of −43° C., which is measurably lower than other solid polymer counterparts.

FIG. 11 illustrates thermogravimetric analysis experiments suggesting that the addition of ceramic filler into the polymers via the solid-state mixing method evidently improved the overall thermal stability, whereby the proposed solid polymer composite electrolyte decomposed at a higher temperature.

FIG. 12 illustrates the mechanical testing on tensile stress and strain relationship that showcases that the ultimate tensile strength of PEO−PPC−NASICON is significantly greater (27.5 MPa) when compared with PEO−PPC, PEO and PPC (15, 10 and 6.5 MPa, respectively). Polyester (PPC) has Young Modulus=135 MPa, polyether (PEO) has a Young Modulus=147 MPa, a mixture of polyester and polyether (PEO−PPC) has a Young Modulus=350 MPa, and lastly the proposed solid polymer composite electrolyte (PEO−PPC−NASICON) has a Young Modulus=620 MPa. Thus, the proposed solid polymer composite electrolyte has by far much higher mechanical strength.

FIG. 13 illustrates Fourier-transform infrared spectroscopy measurements revealing that the PEO+PPC mixture indeed inherited the polymeric characteristics of both PEO and PPC.

FIG. 14 illustrates Raman spectroscopy measurements revealing that the PEO+PPC mixture indeed inherited the polymeric characteristics of both PEO and PPC. Blending PPC with PEO can effectively decrease the crystallinity, thereby improving the ionic conductivity which results in higher Na⁺ mobility.

FIG. 15 illustrates linear sweeping voltage tests reveal that the proposed solid polymer composite electrolyte has lowest oxidization current, therefore having the highest electrochemical stability.

FIG. 16 illustrates nuclear magnetic resonance data revealing that the PPC polymer can spontaneously react with Na metal. Na metal chemically scissors the PPC polymer chain randomly and therefore forms a certain amount of PC monomers (top). Meanwhile, adding NASICON into PPC can mitigate the reaction to a certain extend. By blending in PEO polymer along with NASICON (PEO−PPC−NASICON), the random chain scission reaction with Na can be effectively minimized (bottom).

FIG. 17 illustrates gel permeation chromatography data revealing that the PPC polymer can spontaneously react with Na metal. Na metal chemically scissors the PPC polymer chain randomly and therefore forms a certain amount of PC monomers (left). Meanwhile, adding NASICON into PPC can mitigate the reaction to an certain extent. By blending in PEO polymer along with NASICON (PEO−PPC−NASICON), the random chain scission reaction with Na can be effectively minimized (right).

FIG. 18 illustrates electrochemical performance of the proposed solid polymer composite electrolyte when used in Na metal batteries. The data showcased that the proposed solid polymer composite electrolyte delivered much more efficient and stable Na metal electrode cycling behavior compared to that of conventional solid polymer composite electrolyte. Also, the impedance test shows that the batteries with proposed solid polymer composite electrolyte exhibited 10 folds lower interfacial impedance, which is highly beneficial in enabling highly efficient Na metal electrodes cycling.

FIG. 19 illustrates electrochemical performance of the proposed solid polymer composite electrolyte in Na metal batteries at various current densities and capacities, all of which delivered the Na cycling superior performance.

FIG. 20 illustrates electrochemical performance of the proposed solid polymer composite electrolyte in Na metal batteries at various temperatures, all of which delivered the Na cycling superior performance.

FIG. 21 illustrates control experiments of various polymer and ceramic combination that yielded relatively mediocre electrochemical cycling performances compared to that of the proposed solid polymer composite electrolyte.

FIG. 22 illustrates Na metal electrode cycled with proposed solid polymer composite electrolyte exhibited very smooth and dendrite-free morphology (left), and Na metal electrode cycled with conventional solid polymer composite electrolyte exhibited very rough and dendritic morphology (right).

FIG. 23 illustrates electrochemical performance of the proposed solid polymer composite electrolyte in a full battery at 1C rate. With the proposed solid polymer composite electrolyte, the Na metal full battery delivered far more superior performance in terms of capacity, cycling efficiency, cycling life and stable voltage profile. In sharp contrast, the Na metal battery with conventional solid polymer composite electrolyte delivered significantly inferior performance in every aspect.

FIG. 24 illustrates electrochemical rate performance of the proposed solid polymer composite in a Na metal full battery at various current density rates (top left and top right), the proposed solid polymer composite electrolyte delivered far more superior performances compared to conventional PEO solid-state electrolyte. The electrochemical performance of proposed solid polymer composite in a Na metal full battery at various temperatures is also shown (bottom).

FIG. 25 illustrates electrochemical performance of the proposed solid polymer composite electrolyte in a Na-sulfur battery. With the proposed solid polymer composite electrolyte, the Na-sulfur battery delivered far more superior performance in terms of capacity, cycling efficiency, cycling life and stable voltage profile. In sharp contrast, the Na-sulfur battery with conventional solid polymer composite electrolyte delivered significantly inferior performance in every aspect.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Sodium based batteries are the next-generation battery technology due to much lower cost and the capability of high performance. With the merits of the naturally abundant sodium resource and similar electrochemical characteristics to that of conventional lithium ion batteries, sodium based batteries have been widely studied for enabling more economical and practical battery systems. In the quest of searching for lower cost and high-performance alternatives, many recent studies focus on developing battery chemistries based on sodium materials.

Specifically, sodium metal anodes possess a high theoretical specific capacity and low electrochemical potential and exhibit an overall similar electrochemical behavior as the lithium anode. The pairing of the sodium metal anode with a high capacity can lead to batteries with much higher theoretical energy density than the state-of-the-art lithium-ion batteries. As a result, these high energy density batteries based on the sodium metal anode have quickly spurred intense research interests.

Nevertheless, the commercialization of the sodium metal anode is still largely hindered by a number of challenges, including metallic sodium dendrite growth, unstable solid electrolyte interphase formation, and large volume change. The sodium metal battery is considered one of the best technologies for enabling an economically viable high-performance energy storage solution, especially for the emerging battery chemistry with energy densities comparable to that of fossil fuels. However, inferior ionic conductivity and large interfacial resistance between the electrolyte and an electrode of sodium metal batteries pose challenges for various solid-state electrolytes in sodium metal batteries as well as other battery and energy storage device systems.

Accordingly, a need exists for more effective non-aqueous electrolytes and methods of making them. Various embodiments of the present disclosure address the aforementioned need.

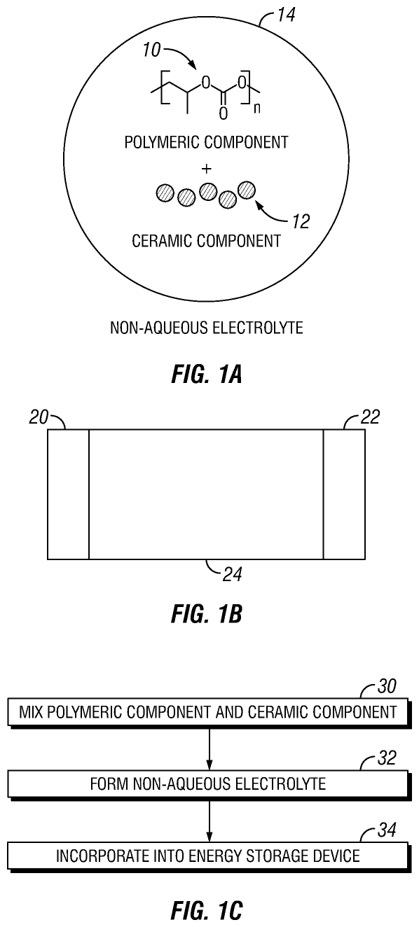

In some embodiments, the present disclosure pertains to non-aqueous electrolytes that include a polymeric component and a ceramic component. In some embodiments, illustrated in FIG. 1A, the non-aqueous electrolytes of the present disclosure includes a polymeric component 10 and a ceramic component 12 associated with the polymeric component 10 to thereby form the non-aqueous electrolyte 14. In some embodiments, the polymeric component 10 includes at least one of a polyester-based polymer, a polyether-based polymer, or combinations thereof. In some embodiments, the ceramic component 12 includes inorganic materials.

Additional embodiments of the present disclosure pertain to energy storage devices. In some embodiments, illustrated in FIG. 1B, the energy storage devices can include an anode (20), a cathode (22), and a non-aqueous electrolyte (24) of the present disclosure.

Further embodiments of the present disclosure pertain to methods of making the non-aqueous electrolytes of the present disclosure. In some embodiments illustrated in FIG. 1C, the methods of the present disclosure generally include one or more of the following steps of: mixing a polymeric component and a ceramic component (step 30) and forming the non-aqueous electrolyte (step 32). In some embodiments, the method can further include a step of incorporating the non-aqueous electrolyte into an energy storage device (step 34).

As set forth in more detail herein, the non-aqueous electrolytes, energy storage devices, and methods of making the non-aqueous electrolytes of the present disclosure can have numerous embodiments. For instance, the non-aqueous electrolytes of the present disclosure can include various polymeric components, ceramic components, and properties. Additionally, the non-aqueous electrolytes of the present disclosure can have various ratios of polymeric components to ceramic components.

Furthermore, the energy storage devices of the present disclosure can include various anodes, cathodes, non-aqueous electrolytes, and numerous properties. Various methods may also be utilized to make the non-aqueous electrolytes of the present disclosure.

Non-Aqueous Electrolytes

As set forth in more detail herein, the non-aqueous electrolytes of the present disclosure can include various components and have various properties. For instance, in some embodiments, the non-aqueous electrolytes can include various polymeric components and ceramic components. Moreover, the non-aqueous electrolytes of the present disclosure may be associated with anodes and cathodes in various manners to form energy storage devices. In addition, the non-aqueous electrolytes may have various advantageous properties.

Polymeric Components

The non-aqueous electrolytes of the present disclosure can include various types of polymeric components. For instance, in some embodiments, the polymeric component is in the form of a polymer composite. In some embodiments, the polymeric component is capable of inhibiting dendrite formation on electrodes.

In some embodiments, the polymeric component includes various polymers such as, without limitation, aliphatic polymers, semi-aromatic polymers, aromatic polymers, polyether-based polymers, polyester-based and polyether-based polymers, and combinations thereof.

In some embodiments, the polymeric component includes a polyester-based polymer. In some embodiments, the polyester-based polymer includes, without limitation, polyglycolide, polyglycolic acid (PGA), polylactic acid (PLA), polycaprolactone (PCL), polyhydroxyalkanoate (PHA), polyhydroxybutyrate (PHB), polyethylene adipate (PEA), polybutylene succinate (PBS), polyethylene terephthalate (PET), polybutylene terephthalate (PBT), polytrimethylene terephthalate (PTT), polyethylene naphthalate (PEN), polypropylene carbonate (PPC), polyethylene carbonate (PEC), and combinations thereof. In some embodiments, the polyester-based polymer includes, without limitation, polypropylene carbonate (PPC), polyethylene carbonate (PEC), and combinations thereof.

In some embodiments, the polymeric component includes polyether-based polymers. In some embodiments, the polyether-based polymers include, without limitation, paraformaldehyde, polyethylene glycol (PEG), polypropylene glycol (PPG), polytetramethylene glycol (PTMG), polytetramethylene ether glycol (PTMEG), polyoxymethylene (POM), polyacetal, polyformaldehyde, polyethylene oxide (PEO), polyoxyethylene (POE), polypropylene oxide (PPDX), polyoxypropylene (POP), polytetrahydrofuran (PTHF), and combinations thereof. In some embodiments, the polyether-based polymers include polyethylene glycol (PEG).

In some embodiments, the polymeric component can include, for example, a mixture of polyester (PPC) and polyether (PEO), or a mixture of polyester (PEC) and polyether (PEO).

In some embodiments, the weight percent of the polymeric component in the non-aqueous electrolyte is between 0.1 wt % to 25 wt %. In some embodiments, the weight percent of the polymeric component in the non-aqueous electrolyte is between 25 wt % to 50 wt %. In some embodiments, the weight percent of the polymeric component in the non-aqueous electrolyte is between 50 wt % to 75 wt %. In some embodiments, the weight percent of the polymeric component in the non-aqueous electrolyte is between 75 wt % to 99.9 wt %. In some embodiments, the weight percent of the polymeric component in the non-aqueous electrolyte is about 37 wt %. In some embodiments, the weight percent of the polymeric component in the non-aqueous electrolyte is about 48 wt %. In some embodiments, the weight percent of the polymeric component in the non-aqueous electrolyte is about 85 wt %.

In some embodiments, the polymeric component includes multiple components with varying weight percentages. For instance, in some embodiments, the polymeric component includes PEO and PPC at a combined weight percentage of 85 wt %. In some embodiments, the polymeric component includes PEO and PPC at weight percentages of 48 wt % and 37 wt %, respectively. In some embodiments, the polymeric component includes PEO and PPC at weight percentages of 43 wt % and 42 wt %, respectively. In some embodiments, the polymeric component includes PEO and PPC at weight percentages of 85 wt % and 0 wt %, respectively.

Ceramic Components

The non-aqueous electrolytes of the present disclosure can include various types of ceramic components. For instance, in some embodiments, the ceramic components can include inorganic materials. In some embodiments, the ceramic components include ceramic electrolytes.

In some embodiments, the inorganic materials include, without limitation, sodium super ionic conductors (NASICON). In some embodiments, the NASICONs can have a chemical formula of Na₁₊ₓZr₂SiₓP₃₋ₓO₁₂. In some embodiments, x is greater than zero and less than three. In some embodiments, the NASICON is Na₃Zr₂Si₂PO₁₂. In some embodiments, the NASICONs can be in the optimized form through either chemical doping or surface engineering. In some embodiments, the surface engineered NASICONs have ultra-thin layer of two-dimensional surface coatings, such as graphene-like 2D surface coatings. See, e.g., ACS Appl. Mater. Interfaces 2019, 11, 5, 5064-5072.

In some embodiments, the weight percent of the ceramic component in the non-aqueous electrolyte is between 0.1 wt % to 25 wt %. In some embodiments, the weight percent of the ceramic component in the non-aqueous electrolyte is between 25 wt % to 50 wt %. In some embodiments, the weight percent of the ceramic component in the non-aqueous electrolyte is between 50 wt % to 75 wt %. In some embodiments, the weight percent of the ceramic component in the non-aqueous electrolyte is between 75 wt % to 99.9 wt %. In some embodiments, the weight percent of the ceramic component in the non-aqueous electrolyte is 15 wt %.

Ceramic Component:Polymeric Component Ratio

The non-aqueous electrolytes of the present disclosure can include various ceramic to polymeric components having various ratios of polymeric components to ceramic components. For instance, in some embodiments, the weight ratio of the polymeric component to the ceramic component is 50:50. In some embodiments, the weight ratio of the polymeric component to the ceramic component is 25:75. In some embodiments, the weight ratio of the polymeric component to the ceramic component is 75:25. In some embodiments, the weight ratio of the polymeric component to the ceramic component is 90:10. In some embodiments, the weight ratio of the polymeric component to the ceramic component is 85:15.

In some embodiments, the polymeric component and ceramic component can include, without limitation, PEO−PPC−NASICON. In some embodiments, the PEO:PPC:NASICON ratio is 48:37:15 (e.g., the PEO is 48 wt %, the PPC is 37 wt %, and the NASICON is 15 wt %).

Properties

As set forth in further detail herein, the non-aqueous electrolytes of the present disclosure can have various properties. For instance, in some embodiments, the non-aqueous electrolytes are solid-state electrolytes. In some embodiments, the non-aqueous electrolytes are in a composite form. In some embodiments, the non-aqueous electrolytes have a structure such that the polymeric components and the ceramic components are intertwined with one another. In some embodiments, the non-aqueous electrolytes have a structure such that the polymeric component and the ceramic component are wrapped around one another.

In some embodiments, the non-aqueous electrolyte structure is homogenous. In some embodiments, the polymeric component and the ceramic component are homogenously intertwined with one another. In some embodiments, the non-aqueous electrolyte structure is dispersed.

In some embodiments, the non-aqueous electrolytes have ionic conductivity greater than 1×10⁻⁴ S/cm. In some embodiments, the non-aqueous electrolytes have ionic conductivity greater than 1×10⁻⁵ S/cm. In some embodiments, the non-aqueous electrolytes have ionic conductivity greater than 5×10⁻⁵ S/cm.

In some embodiments, the non-aqueous electrolytes have a Young's Modulus greater than 100 MPa. In some embodiments, the non-aqueous electrolytes have a Young's Modulus greater than 200 MPa. In some embodiments, the non-aqueous electrolytes have a Young's Modulus greater than 500 MPa.

In some embodiments, the non-aqueous electrolytes of the present disclosure have high strength compared to traditional non-aqueous electrolytes (e.g., solid-state electrolytes). In some embodiments, the non-aqueous electrolytes of the present disclosure have high flexibility compared to traditional non-aqueous electrolytes. In some embodiments, the non-aqueous electrolytes of the present disclosure can form thinner polymer films compared to traditional non-aqueous electrolytes.

Energy Storage Devices Having Non-Aqueous Electrolytes

As set forth in further detail below, the non-aqueous electrolytes of the present disclosure can be utilized in numerous manners to form various energy storage devices. For example, in some embodiments, the non-aqueous electrolytes can be associated with an anode and a cathode to form an energy storage device.

Anodes

In some embodiments, the anode includes, without limitation, a nonmetallic anode, a sodium-based anode, a metallic anode, and combinations thereof. In some embodiments, the anode is a sodium-based anode.

In some embodiments, the anodes include various components. For example, in some embodiments, the components include, without limitation sodium, aluminum, zinc, magnesium, titanium, tin, cadmium, lead, copper, lithium, metal alloys, and combinations thereof.

Cathodes

In some embodiments, the cathode includes, without limitation, a nonmetallic cathode, a sodium-based cathode, a metallic cathode, and combinations thereof. In some embodiments, the cathode is a sodium-based cathode.

In some embodiments, the cathodes include various components. For example, in some embodiments, the components include, without limitation, sodium, vanadium, phosphor, sulfur, aluminum, zinc, magnesium, titanium, tin, cadmium, lead, copper, lithium, metal alloys, and combinations thereof.

In some embodiments, the cathode includes sodium vanadium phosphate (NVP). In some embodiments, the sodium vanadium phosphate is Na₃V₂(PO₄)₃.

Energy Storage Devices

The non-aqueous electrolytes of the present disclosure can be incorporated into various energy storage devices. For instance, in some embodiments, the energy storage device is a battery. In some embodiments, the batteries include sodium-based batteries. In some embodiments, the sodium-based batteries can include, without limitation, sodium metal batteries, sodium sulfur batteries, sodium-ion batteries, sodium-air batteries, sodium oxygen batteries, sodium-carbon dioxide batteries, sodium-sulfur metal batteries, sodium-containing metal batteries, and combinations thereof.

Energy Storage Device Properties

As set forth in further detail herein, the energy storage devices utilizing the non-aqueous electrolytes of the present disclosure can have numerous properties. For instance, in some embodiments, the energy storage devices have an interfacial impedance between at least one of the cathode or anode and the electrolyte of approximately 500 ohm/cm². In some embodiments, the energy storage devices have an initial specific capacity of about 100 mAh/g. In some embodiments, the energy storage devices retain about 85 mAh/g capacity after cycling for 500 cycles. In some embodiments, the energy storage devices exhibit only about a 15% capacity decay over 500 cycles. In some embodiments, the energy storage devices have an initial specific capacity of about 500 mAh/g. In some embodiments, the energy storage devices retain about 480 mAh/g capacity after cycling for 100 cycles. In some embodiments, the energy storage devices exhibits only about a 4% capacity decay over 100 cycles.

In some embodiments, the cathode and the anode of the energy storage devices of the present disclosure are non-dendritic. In some embodiments, at least one of the anode or cathode electrochemically reduce a length of the polyester-based polymer of the polymeric components from a long-chain polymer to a short-chain polymer. In some embodiments, the short-chain polymer acts as an interfacial wetting agent that improves interfacial contact between the electrolyte and at least one of the anode or cathode. In some embodiments, the improved interfacial contact improves interfacial conductivity by lowering interfacial impedance. In some embodiments, the improved interfacial contact impedes dendrite formation on at least one of the anode or cathode. In some embodiments, the energy storage devices have smoother morphology at an anode or electrode surface after repeated operation. In some embodiments, the energy storage devices have a homogenous and uniform morphology.

Methods of Making Non-Aqueous Electrolytes

Additional embodiments of the present disclosure pertain to methods of making the non-aqueous electrolytes of the present disclosure. Such methods generally include mixing a polymeric component (e.g., polymeric components discussed above) with a ceramic component (e.g., ceramic components discussed above), and forming a non-aqueous electrolyte. In some embodiments, the polymeric component includes a polyester-based polymer and a polyether-based polymer. In some embodiments, the ceramic component includes inorganic materials, such as those previously described.

In some embodiments, the mixing includes, without limitation, solid-state mixing. In some embodiments, the solid-state mixing includes, without limitation, ball milling. In some embodiments, the ball milling includes high-energy ball milling.

In some embodiments, the solid-state mixing yields a homogenous mixture of the polymeric component and the ceramic component. In some embodiments, the homogenous mixture is obtained via mechanical wrapping of the ceramic component with the polymeric component during the solid-state mixing. In some embodiments, the mechanical wrapping of the ceramic component with the polymeric component results in an ionically conductive solid polymer composite electrolyte. In some embodiments, the mechanical wrapping of the ceramic component with the polymeric component results in a more amorphous region that can facilitate ionic transport by improving segmental motion of the polymeric component.

In some embodiments, the methods of the present disclosure can further include a step of incorporating the non-aqueous electrolyte into an energy storage device. In some embodiments, the energy storage device is a battery, such as a sodium metal battery.

Applications and Advantages

As set forth in further detail herein, the present disclosure can have various advantages. For instance, in some embodiments, the non-aqueous electrolytes of the present disclosure have at least the valuable features of having high ionic conductivity and low interfacial resistance. Furthermore, the non-aqueous electrolytes of the present disclosure can provide superior performance, scalability and ease of manufacturing (e.g., manufactured as thin and flexible films). In some embodiments, the non-aqueous electrolytes of the present disclosure can have high mechanical strength and low cost. In some embodiments, the non-aqueous electrolytes of the present disclosure can utilize green chemistry, as compared to traditional non-aqueous electrolytes (e.g., solid-state electrolytes).

Additionally, in some embodiments, the non-aqueous electrolytes of the present disclosure show improved mechanical strength. In some embodiments, the non-aqueous electrolytes of the present disclosure provide for an extremely thin and highly flexible solid polymer composite electrolyte film (e.g., approximately 20 microns) with improved mechanical strength. Thus, because of the high strength, flexibility, and thin polymer film capabilities, the non-aqueous electrolytes of the present disclosure are highly commercially viable (unlike the traditional solid-state electrolytes that are bulky, structurally weak, and non-flexible).

Furthermore, in some embodiments, the non-aqueous electrolytes of the present disclosure provide for a polymer composite electrolyte that eliminates disadvantages in current technology, such as, by being highly flexible, easy to manufacture, having low interfacial impedance, having high throughput, and utilizing low cost polymers. Moreover, in some embodiments, the non-aqueous electrolytes of the present disclosure incorporate the major advantage of solid-state ceramic electrolytes of having very high ionic conductivity.

Additionally, in some embodiments, the non-aqueous electrolytes of the present disclosure provide for a solid polymer composite electrolyte that is far superior to conventional solid polymer electrolytes previously explored. Therefore, in some embodiments, the non-aqueous electrolytes of the present disclosure provide for a solid polymer composite electrolyte that has the advantages of both ceramic-type solid electrolytes and polymer-type solid electrolytes, while eliminating the shortcoming of scalability and manufacturability challenges of ceramic-type solid electrolytes. In addition, the non-aqueous electrolytes of the present disclosure can operate at much lower temperatures than current solid-state electrolytes.

As such, the non-aqueous electrolytes of the present disclosure can be utilized in various manners and for various purposes. For instance, in some embodiments, the non-aqueous electrolytes can be utilized in energy storage devices. In some embodiments, impedance of the energy storage devices described herein exhibit a 10-fold lower interfacial impedance as compared to conventional battery systems, which is highly beneficial in enabling highly efficient sodium metal electrodes cycling. In some embodiments, ionic conductivity of the energy storage devices disclosed herein is about 100-fold higher than that of a conventional solid polymer composite electrolyte battery systems. In some embodiments, the energy storage devices of the present disclosure deliver superior performance in terms of capacity, cycling efficiency, cycling life, and a stable voltage profiles as compared to conventional battery systems. Moreover, the non-aqueous electrolytes of the present disclosure provide for a significantly improved sodium metal plating/stripping behavior and efficiency with unprecedented low voltage overpotential.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. Polyester-Based Solid Polymer Composite Electrolyte for Electrochemically Superior and High-Performance Sodium Metal Batteries

This Example describes a reactivity-guided optimization solid polymer composite electrolyte with superior electrochemical performance for sodium metal batteries by simultaneously improving the ionic conductivity and interfacial conductivity.

### Example 1.1. Introduction

Rechargeable batteries are the key enabling technology for renewable energy implementation because of its operational efficiency, long cycling life, low maintenance and scalability. Currently, lithium (Li) ion batteries are ubiquitous and responsible for powering much of society, ranging from consumer electronics, electric vehicles, and grid-scale energy storage. However, considering the natural scarcity, geographical constraint as well as increasing material cost associated with Li and cobalt resources, Li ion batteries can be too expensive in the long run to meet the growing demands. In the quest of searching for lower cost and high-performance alternatives, many recent studies focus on developing next-generation battery chemistries based on sodium (Na) material.

With the merits of naturally abundant resource and similar electrochemical characteristics to that of Li-based batteries, Na-based batteries have been widely researched for enabling more cost-effective battery systems. Nevertheless, Na metal batteries still face a number of grand challenges, such as dendrite growth and an unstable solid-electrolyte interphase. Particularly, dendrite growth is the main driving force behind battery short circuit and corresponding safety concern. In this regard, the most effective strategy to suppress dendrite formation relies on implementing a Na⁺ conductive solid-state electrolyte (SSE) that acts as a physical barrier.

SSEs not only can eliminate the safety concerns arising from flammability and liquid electrolyte leakage, they can also enable new battery chemistry owing to their broadened electrochemical window, chemical stability and thermal durability. There are two major classes of SSEs: ceramic and polymer. Ceramic SSEs have the advantage of relatively high ionic conductivity up to 10⁻⁴ S/cm, but they are plagued by the large interfacial impedance because of the poor contact with electrodes. Meanwhile, costly fabrication process, low manufacturing throughput, bulky and rigid pellet format of ceramic SSE inevitably render the commercialization rather unfeasible.

Among the various Na⁺ conducting ceramic SSE, the Na⁺ superionic conductor (NASICON) Na₃Zr₂Si₂PO₁₂ remains to be the most promising material because of its relatively high ionic conductivity of 5×10⁻⁴ S/cm and excellent electrochemical and thermal stabilities. Meanwhile, solid polymer electrolytes (SPEs) have relatively lower ionic conductivity, but they have excellent interfacial compatibility and conductivity with electrodes by compensating the volume change through elastic deformation. More importantly, SPEs are low cost, easily processable, scalable, mechanically flexible and thin. Therefore, from a commercial point of view, SPEs are much more viable than ceramic SSE. SPEs are prepared by dissolving the corresponding salts in long chain polymer matrix.

A number of suitable polymers have been used as the host material for SPEs, including polyether polymer poly(ethylene oxide) (PEO), and polyester polymer polypropylene carbonate (PPC). Among these polymer candidates, PEO receives the most extensive research interests because of its ideal molecular structure (—CH₂—CH₂—O—)ₙ that can facilitate Li/Na salt dissociation to generate metal complex to effectively enable ion transport through segmental motion, while the backbone of PEO polymer provides the macromolecular flexibility for sufficient ion dynamics.

In a SPE system, the polymer acts as the host for ion transport through its segmental motion, in which the ionic conductivity is based on mobile charged carriers hopping along a polymer chain. Although PEO is a reliable polymer host, the high crystallinity of PEO leads to compact packing of parallel polymer chains that impede Na⁺ transport, resulting in sluggish polymer segmental motion at room temperature and therefore low ionic conductivity and high interfacial impedance. Generally, Na⁺ conductivity of polymer SSE can be improved by increasing the amorphous region within the polymer host and the concentration of dissociated Na⁺. Thus, blending PEO with a secondary polymer or ceramic filler can effectively minimize the overall local reorganization of polymer chains to shorten the ionic diffusion pathways for enhanced ionic conductivity, thereby increasing the Na⁺ conductivity by decreasing the overall crystallinity phase.

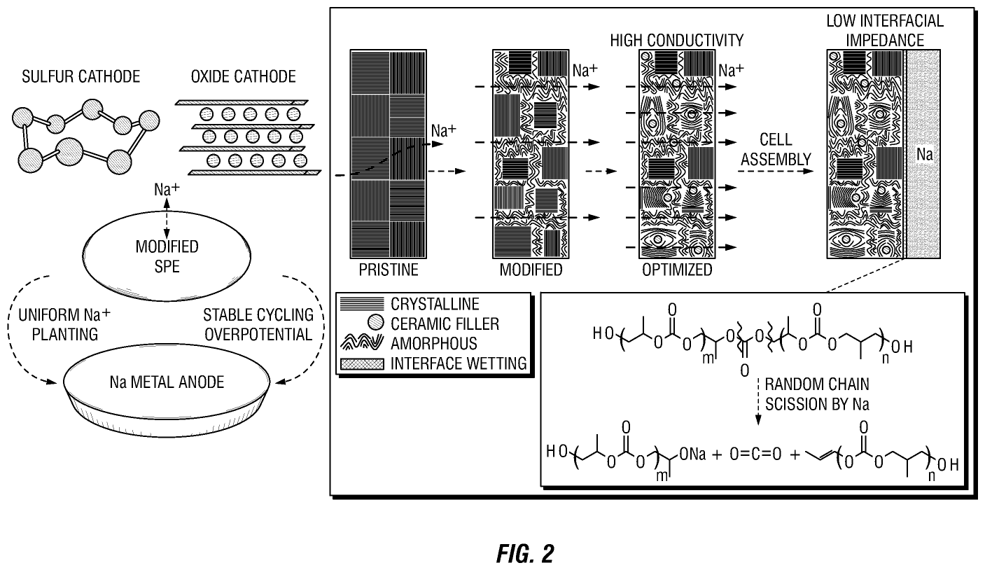

In this Example, Applicants report a facile and scalable method to simultaneously improve bulk ionic conductivity, interfacial ionic conductivity, electrochemical window as well as mechanical property of a solid-state polymer composite electrolyte based on synergic effects of both polyester (i.e. PPC) and polyether (i.e. PEO) for the first time applied in sodium-based battery (FIG. 2). Firstly, Applicants demonstrated that polyester polymer (i.e. PPC) can serve as an ideal additive in polyether (i.e. PEO) solid polymer electrolyte to effectively improve bulk ionic conductivity, interfacial ionic conductivity, mechanical property as well as chemical stability all at once.

Polyester (e.g., PPC) solid polymer electrolytes have previously been applied in Li batteries owing to its strong polar group [—O—(C═O)—O—] that can easily dissolve alkali metal salts and minimize ion aggregations. However, polyester has not yet been applied in Na batteries. Notably, Applicants observed for the first time the phenomenon that Na metal can act as a catalyst to randomly truncate long chain polyester into shorter chain, and this significantly improves the interfacial conductivity between solid polymer electrolyte and electrodes but can also lead to battery short-circuit and hence safety concern. Therefore, Applicants discover that, although polyester (e.g., PPC) alone is not a suitable solid polymer electrolyte for Na system due to its reactivity with Na metal anode (e.g., it can cause battery short-circuit), it can induce a powerful synergetic effect when combined with polyether (e.g., PEO) to give rise to a superior solid-state polymer composite electrolyte to simultaneously improve ionic conductivity and interfacial conductivity.

To further optimize the electrochemical performance and mechanical rigidity of modified solid polymer electrolyte, Applicants incorporated the modified NASICON reported in Applicants' previous work as active ceramic fillers into the modified solid polymer electrolyte system by high energy ball milling to effectively decrease the crystalline phase further. Lastly, Applicants investigated the fundamental mechanism behind the reactivity between polyester and Na metal through a series of characterizations, and systematically elucidated the relationship between polyester concentration and Na plating/stripping performance.

Overall, Applicants present a reactivity-guided optimization solid polymer composite electrolyte with superior electrochemical performance for Na metal batteries by simultaneously improving the ionic conductivity and interfacial conductivity for the first time, and this Example therefore provides new insights for the development of high-performance all-solid-state batteries. Altogether, the solid-state polymer composite electrolyte exhibited superior ionic conductivity, interfacial conductivity, electrochemical and chemical stability, mechanical property, and thermal stability.

Overall, the solid-state polymer composite electrolyte has at least the following merits: (1) highest ionic conductivities reported for sodium-based solid-state polymer electrolyte; (2) lowest interfacial impedance reported for sodium-based solid-state polymer electrolyte; (3) best electrochemically stability reported for sodium-based solid-state polymer electrolyte; (4) exceptional chemical and thermal stability for sodium-based solid-state polymer electrolyte; (5) substantial improvement on mechanical strength for solid-state polymer electrolyte; and (6) environmentally friendly, and highly commercially scalable due to facile preparation procedures.

### Example 1.2. Preliminary Data on Solid-State Polymer Composite Electrolyte Optimization and Discovery of Unique Reactivity Between Polyester Polymer (i.e. PPC) with Na Metal

In this Example (FIG. 2), Applicants report a facile and scalable method to simultaneously improve bulk ionic conductivity, interfacial ionic conductivity, electrochemical window as well as mechanical property of a solid-state polymer composite electrolyte based on polyester (i.e. PPC, PEC) for the first time applied in sodium-based battery. Firstly, Applicants demonstrated that polyester polymer can serve as an ideal additive in PEO-based solid polymer electrolyte to effectively improve bulk ionic conductivity, interfacial ionic conductivity, mechanical property as well as chemical stability all at once. Polyester solid polymer electrolyte have been applied in Li batteries owing to its strong polar group [—O—(C═O)—O—] that can easily dissolve alkali metal salts and minimize ion aggregations. However, polyester has not yet been applied in Na batteries.

Notably, Applicants discovered a phenomenon that Na metal can act as a catalyst to randomly truncate long chain polyester (i.e. PPC, PEC) into shorter chain, called random chain scission reaction, and this significantly improves the interfacial conductivity between solid polymer electrolyte and electrodes but can also lead battery short-circuit and hence severe safety issue. Therefore, Applicants reveal that, although polyester alone is not a suitable solid polymer electrolyte for Na system due to its reactivity with Na metal anode (battery short-circuit), it can induce a powerful synergetic effect when combined with PEO to give rise to a superior composite solid polymer electrolyte to greatly improve interfacial conductivity. Then, to further optimize the electrochemical performance and mechanical rigidity of modified solid polymer electrolyte, Applicants incorporated the modified NASICON reported in Applicants' previous work as active ceramic fillers into the modified solid polymer electrolyte system by high energy ball milling to effectively decrease the crystalline phase further.

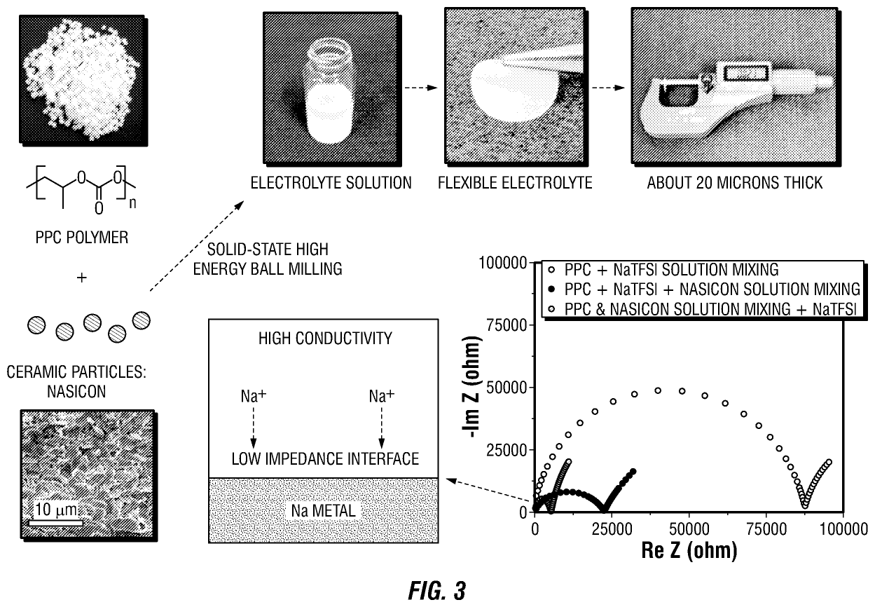

The process flowchart displayed in FIG. 3 showcases the method of solid-state mixing polymer and ceramic to form solid-state polymer composite electrolyte, these materials are all environmentally friendly and non-toxic materials. The solid-state mixing method is demonstrated using a high-energy ball milling machine to mechanically grind polymer and ceramic together to provide intrinsically better wrapping between polymer and ceramic for much more homogenous mixing as opposed to conventional solution mixing method. The electrolyte solution can be prepared and produced at a large scale; therefore, it is a highly scalable and commercially viable product. The thickness of the solid-state polymer composite electrolyte thin film can be adjusted accordingly based on the preference of specific battery configurations and applications.

As demonstrated in FIG. 3, the solid-state polymer composite electrolyte thin film can be fabricated to be as thin as 20 microns or even lower, which is completely in the same thickness range as the commercial polymer separate used in everyday lithium-ion batteries. The preliminary electrochemical impedance spectrometry data clearly indicates that the solid-state polymer composite electrolyte synthesized by the proposed solid-state mixing method delivered significantly lower ionic resistance compared to the one synthesized via conventional solution mixing method. Therefore, these are empirical evidence that the proposed solid-state polymer composite electrolyte can be eco-friendly, manufacturable, scalable, mechanical flexible and thin, and much more ionically conductive than the conventional counterpart.

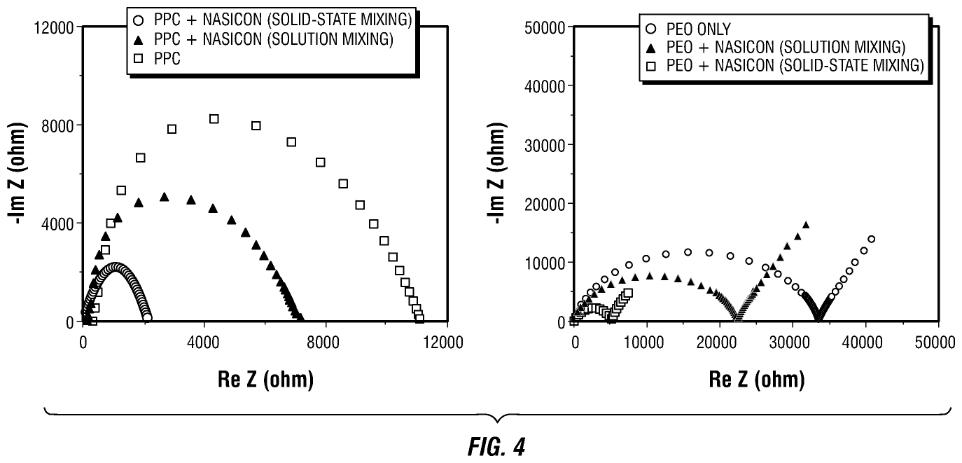

The subsequent analysis of electrochemical impedance spectrometry data further validates that solid-state mixing method (FIG. 4), as compared to conventional solution mixing method, provided the proposed solid polymer composite electrolytes with significantly lower ionic resistance and therefore higher ionic conductivity. Here, the preliminary data showing that the ionic resistances of 2000 ohms and 5000 ohms for solid-state mixed PPC+NASICON and PEO+NASICON, respectively. These numbers are substantial improvements from solution mixed PPC+NASICON (7000 ohm) and PEO+NASICON (22000 ohm). Therefore, the proposed solid-state mixing method proved to consistently improve the ionic transport property of different types of solid polymer electrolytes, such as polyether-based (i.e. PEO) and polyester-based (i.e. PPC) electrolytes. Hence, the proposed method can be a universal approach to various solid polymer electrolyte systems for improving ionic transport performances.

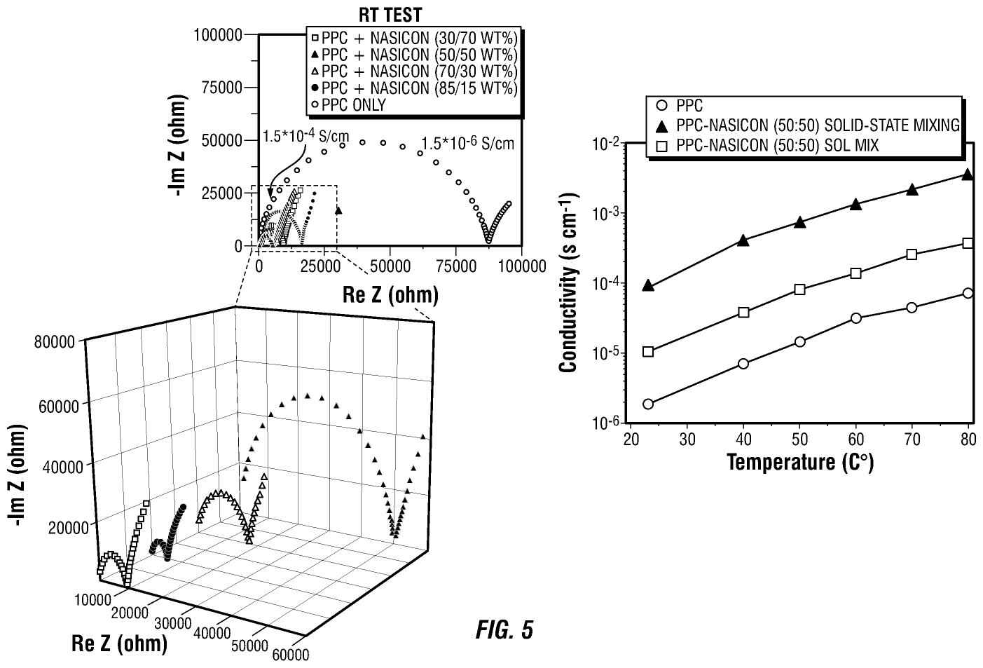

The further optimization of polyester (i.e. PPC) and ceramic filler (i.e. NASICON) mixing ratio was evaluated by electrochemical impedance spectrometry (FIG. 5) test indicates the solid polymer composite electrolyte synthesized by the proposed solid-state mixing method with the optimized recipe (50/50 wt % of polyester and ceramic filler) has about 100 folds higher ionic conductivity than that of solid polymer composite electrolyte made by conventional approach. The design of experiment for optimized polymer to ceramic ratio reveals that the performance can be maximized only at a certain ratio of 50/50 wt %, as too much polymer or ceramic can all lead to decreasing ionic conductivity due to more sluggish polymeric ionic transfer and poor interfacial conductivity caused by ceramic particles, respectively. This superior ionic conductivity of the proposed solid polymer composite electrolyte remains true in various temperatures, and thus proved the next-level performance of the proposed solid polymer composite electrolyte at all conditions.

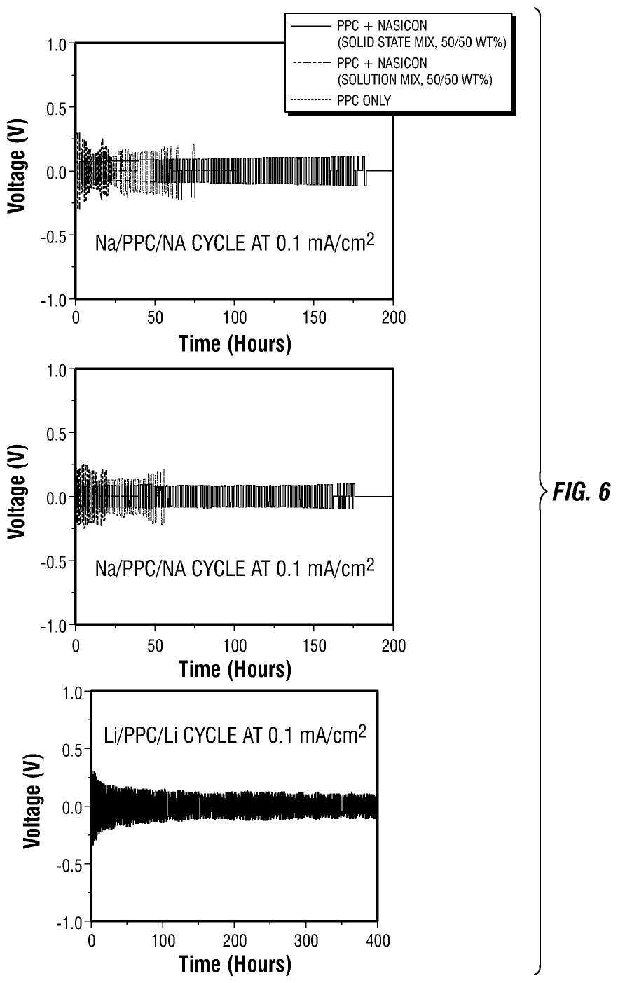

The electrochemical cycling performances (FIG. 6) of Na metal batteries equipped with optimized polyester polymer recipe (i.e. PPC, PEC) alone without polyether polymer (i.e. PEO), and batteries exhibited short-circuit (voltage drops to near zero) due to the random chain scission by Na. It is noteworthy to point out that even though all Na metal batteries eventually became short-circuit, one can clearly observe that the polyester polymer fabricated via solid-state mixing not only delivered significantly longer cycling life of 175 hours (vs. 70 hours from solution mixing counterpart), it also effectively displays lower voltage overpotential of 0.25 volt (vs. 45 volt from solution mixing counterpart). These are the scientific indications that the proposed solid-state mixing provides much more homogenous polymer-ceramic composite to minimize the random chain scission reaction with Na and therefore prolong cycling life while enabling a better ionic pathway for Na ion conduction and therefore lower voltage potential.

Meanwhile, the electrochemical cycling test was done to reveal if lithium, being the elemental neighbor with Na in the alkali metal group of the periodic table, had the same performance characteristics. It was learned that the performances of lithium metal batteries with polyester polymer showed no short-circuit, therefore indicating that the polyester does not react with lithium but only react specifically with Na. The subsequent investigations in this Example are centered around this novel finding on the random chain scission reactivity of Na towards polyester polymer electrolyte by taking advantage of reaction to create a unique solid-state polymer composite electrolyte recipe by taking the synergic effects of polyester polymer (i.e. PPC, PEC) and polyether polymer (i.e. PEO).

### Example 1.3. In-Depth Optimization Via Design of Experiments for the Proposed Solid-State Polymer Composite Electrolyte

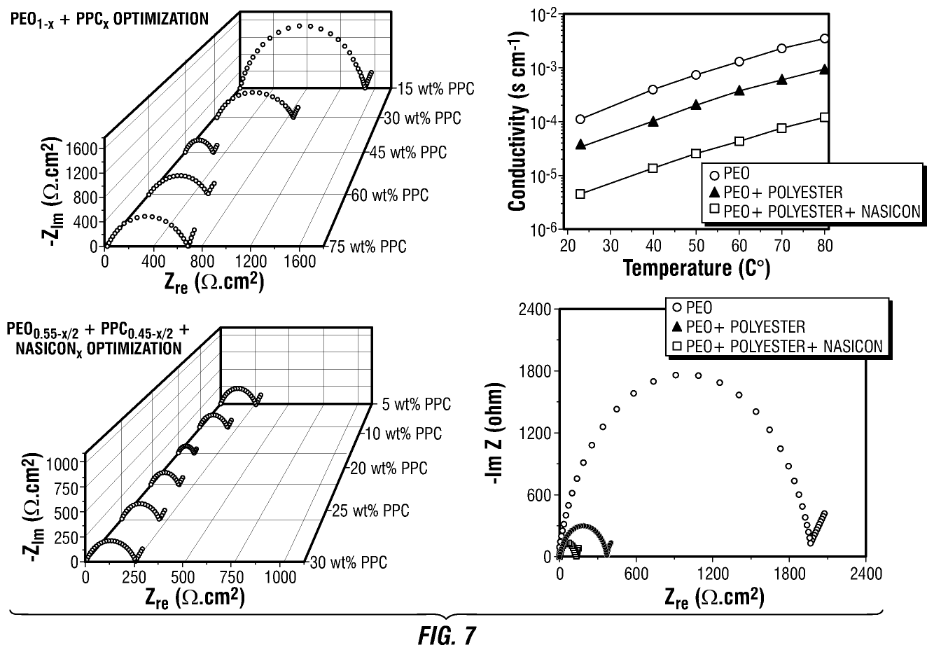

The thorough design of experiment was set up to optimize the proposed solid polymer electrolyte by blending with the polyether polymer (i.e. PEO), polyester polymer (i.e. PPC, PEC) and ceramic filler (i.e. NASICON) to yield a chemically stable, electrochemically superior and mechanically strong high performance PEO−PPC−NASICON solid polymer composite electrolyte (FIG. 7). The first step for a functional solid polymer electrolyte is to incorporate polyether polymer (i.e. PEO) to stabilize polyester polymer (i.e. PPC) from reacting with Na metal. Therefore, the objective is to optimize the ratio between polyether (i.e. PEO) to polyester (i.e. PPC) to achieve the maximum ionic conductivity (FIG. 7, top left). Then, to further improve the electrochemical stability of and ionic conductivity of PEO to PPC mix, an optimized amount of ceramic filler (i.e. NASICON) has be blended in to have the end product of the proposed solid polymer composite electrolyte (FIG. 7, bottom left). The optimized recipe was found to be 48 wt % polyether (i.e. PEO), 37 wt % polyester (i.e. PPC) and 15 wt % ceramic filler (i.e. NASICON). With this optimized recipe, the proposed solid-state polymer composite electrolyte exhibited next-level high ionic conductivities at various temperatures.

Overall, the proposed solid-state polymer composite electrolyte led to about 25 times higher ionic conductivity (0.12 mS/cm) than conventional state-of-the-art PEO solid polymer electrolyte (0.005 mS/cm). This high ionic conductivity is nearly on par with solid-state ceramic electrolyte, which has intrinsically higher conductivity but suffers from extremely poor interfacial conductivity. Therefore, the proposed solid-state polymer composite electrolyte combines the ultimate advantages of both solid polymer electrolyte (high interfacial conductivity) and solid ceramic electrolyte (high ionic conductivity).

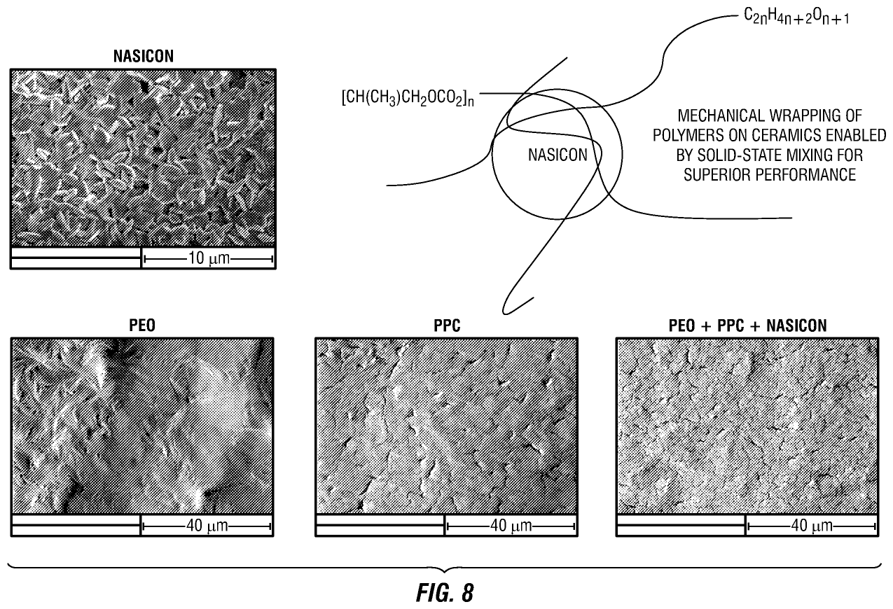

The scanning electron microscope imaging (FIG. 8) displays the microscopic features of ceramic filler (i.e. NASICON), polyether (i.e. PEO), polyester (i.e. PPC), as well as the mixture of the three ingredients that composed the proposed solid-state polymer composite electrolyte. The proposed solid-state polymer composite electrolyte of PEO+PPC+NASICON exhibits exceptionally smooth and homogenous morphology, indicating that the solid-state mixing effectively yields excellent blending of polymers on ceramics, as depicts in the top right.

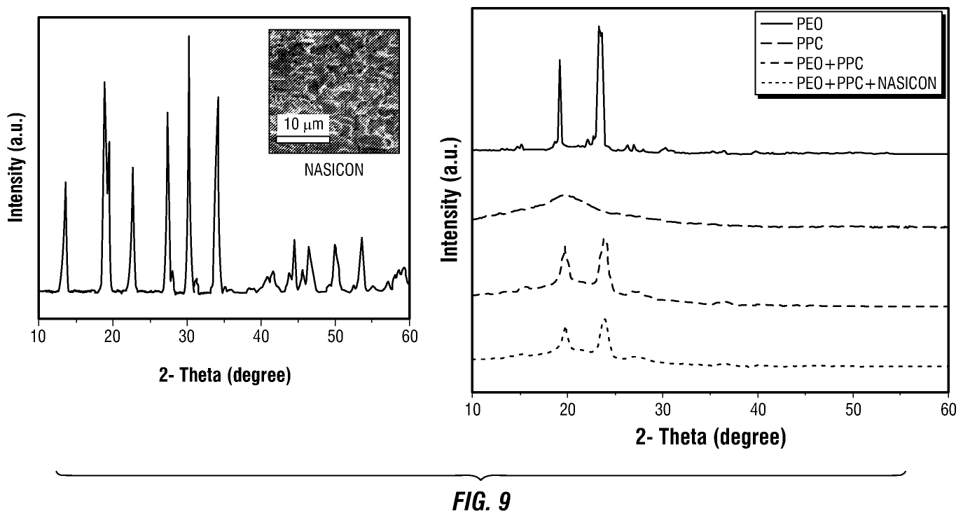

The X-ray diffraction studies (FIG. 9) on ceramic filler (i.e. NASICON), polyether (i.e. PEO), polyester (i.e. PPC), as well as the mixture of PEO+PPC and the proposed solid-state polymer composite electrolyte (PEO+PPC+NASICON) are conducted to study the composition and crystalline structure of these materials. It can be observed that polyether (i.e. PEO) exhibited highly crystalline structure, as indicated by these very distinctive X-ray diffraction peaks; while polyester (i.e. PPC) exhibited a highly amorphous structure, as indicated by no peak but rather a hump. Given the fact that amorphous region of the polymer electrolyte can effectively improve ionic conductivity by acting as a fast ionic transport network, the X-ray diffraction studies revealed that the PEO+PPC showcased a much less profound X-ray diffraction peaks profile and therefore the presence of polyester (i.e. PPC) does effectively make the PEO+PPC mixture more amorphous. Furthermore, the presence of the ceramic filler (i.e. NASICON) in PEO+PPC+NASICON further decreased the crystallinity and increased the amorphous feature, therefore corresponding to significantly higher ionic conductivity.

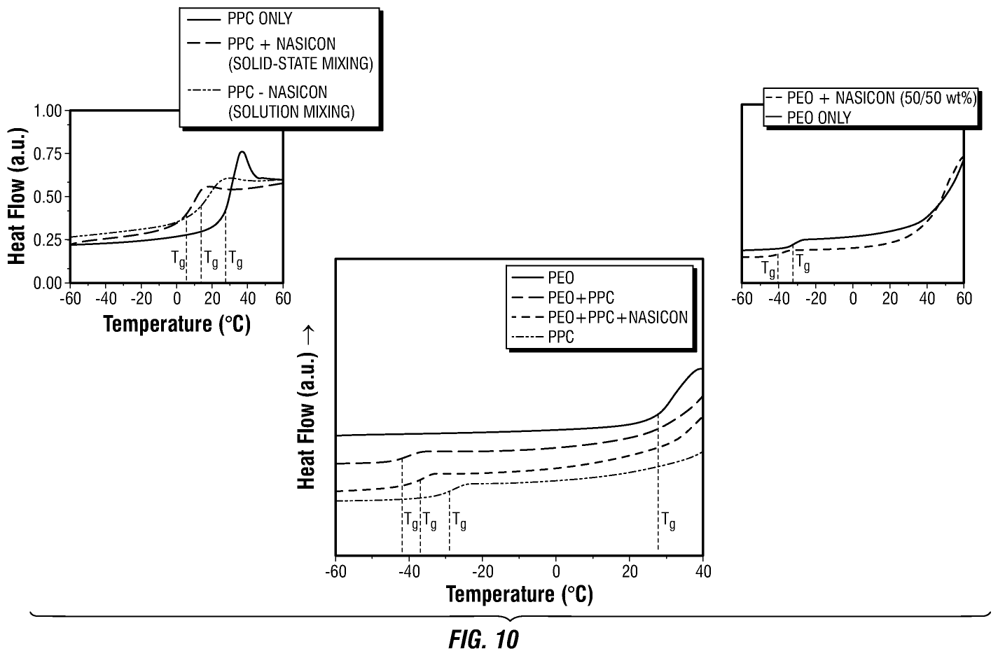

The differential scanning calorimetry test (FIG. 10) was used to determine the glass transition temperature (T_{g}) of polyether (i.e. PEO), polyester (i.e. PPC), as well as the mixture of PEO+PPC and the proposed solid-state polymer composite electrolyte (PEO+PPC+NASICON). Theoretically, the lower T_{g} improves both polymer segmental motion (higher Na⁺ mobility) and interfacial contact (better interface wettability), and therefore greatly enhances the electrochemical performance. Here, the data reveals that glass transition temperature (T_{g}) is effectively lowest in the solid polymer composite electrolyte (PEO+PPC+NASICON) at −43° C., which is measurably lower than PEO+PPC at −37° C., PEO at −29° C. and PPC at 24° C., therefore yielding a much higher ionic conductivity as a result.

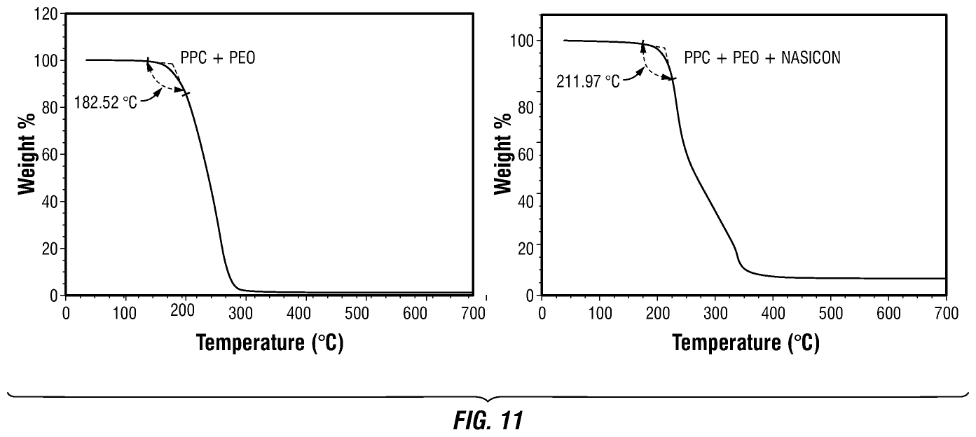

The thermogravimetric analysis (FIG. 11) was designed to determine if the proposed polymer composite electrolyte (PEO+PPC+NASICON) has better thermal stability in which it undergoes thermal decomposition at a higher temperature, therefore conferring more heat resistance. The study showcased that the proposed solid-state polymer composite electrolyte (PEO+PPC+NASICON) indeed exhibited a measurably better thermal stability that decomposed at 211° C. compared to the control group which decomposed at 182° C.

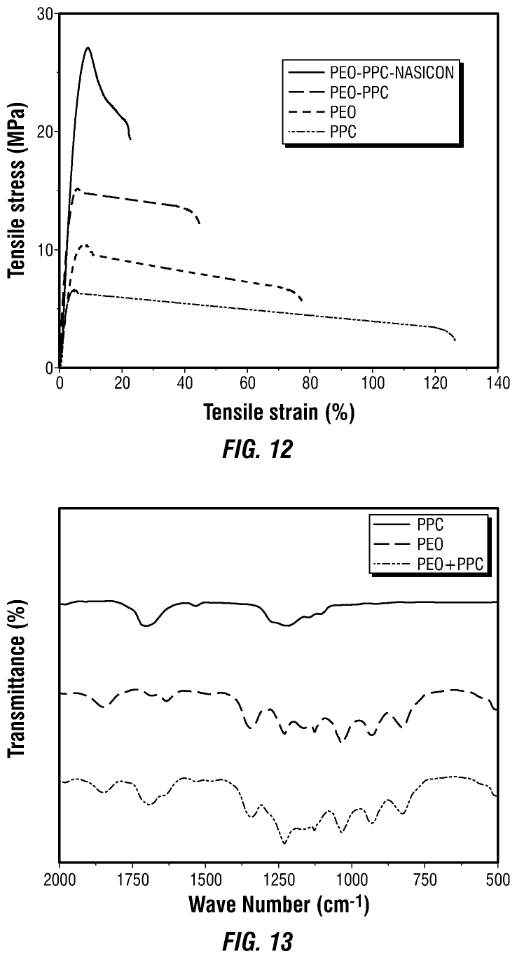

The ultimate tensile strengths (FIG. 12) were obtained for the purpose of comparison of an improved PEO−PPC−NASICON with three control groups of polyether (i.e. PEO), polyester (i.e. PPC), as well as the mixture of PEO+PPC. The engineering stress-strain curves for the polymers show ultimate tensile strength of PEO−PPC−NASICON, which is significantly greater (27.5 MPa) when compared with PEO−PPC, PEO and PPC (15, 10 and 6.5 MPa, respectively). PEO−PPC has also showed a greater tensile strength then PEO and PPC, although weaker than PEO−PPC−NASICON. It is also worth mentioning that in the experiments during initial loading PEO−PPC−NASICON showed the most elastic behavior. The proposed solid polymer composite electrolyte (PEO−PPC−NASICON) has a Young Modulus=620 MPa, polyester (PPC) has Young Modulus=135 MPa, polyether (PEO) has a Young Modulus=147 MPa, and a mixture of polyester and polyether (PEO−PPC) has a Young Modulus=350 MPa. Thus, the proposed solid polymer composite electrolyte has by far much higher mechanical strength.

The Fourier-transform infrared spectroscopy measurement (FIG. 13) was conducted to study the polymeric structures of polyether (i.e. PEO), polyester (i.e. PPC), as well as the mixture of PEO+PPC. The result illustrates that the PEO+PPC mixture indeed inherited the polymeric characteristics of both PEO and PPC. Blending PCC with PEO can effectively decrease the crystallinity, thereby improving the ionic conductivity. This in turn results in higher Na ion mobility.

Interacting C═O groups in PPC are considered to enable migration of Na ion faster than that coordinated with ether chains in PEO. Therefore, the proposed solid-state polymer composite electrolyte inherited the characteristic of polyester (i.e. PPC) effectively becomes more Na ion conductive.

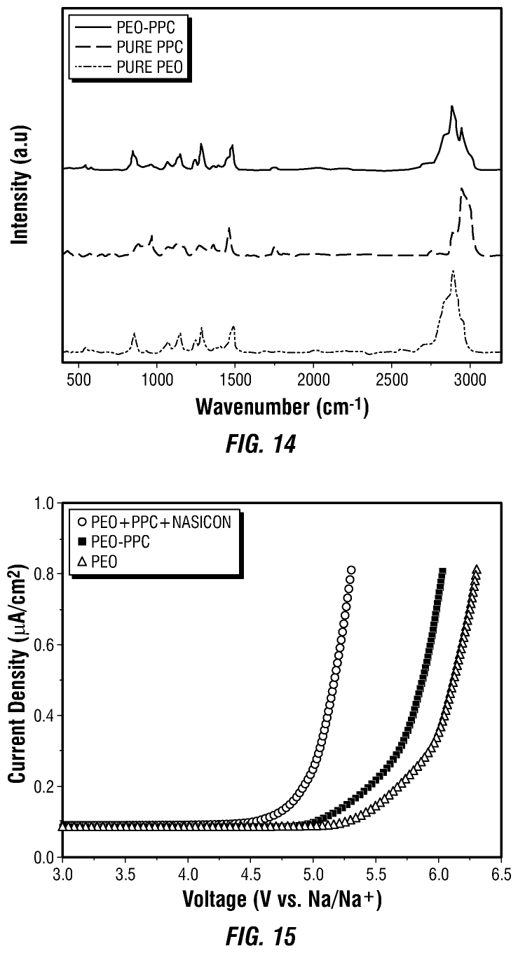

Raman spectroscopy measurement (FIG. 14) reveals that the PEO+PPC mixture indeed inherited the polymeric characteristics of both PEO and PPC. Therefore, the proposed solid-state polymer composite electrolyte of blending PCC with PEO can effectively decrease the crystallinity, thereby improving the ionic conductivity and resulting in higher Na⁺ mobility.

The linear sweeping voltage test (FIG. 15) was constructed to study the decomposition voltage of the proposed solid-state polymer composite electrolyte against Na metal electrode, and compared it against other polymers. The results clearly showed that the proposed solid-state polymer composite electrolyte has lowest oxidization current and started decomposing at much higher voltage compared to the control groups, therefore exhibiting the highest electrochemical stability.

### Example 1.4. Experimental Confirmations on the Proposed Solid-State Polymer Composite Electrolyte (PEO−PPC−NASICON) Effectively Minimized Reactivity Between its Polyester (i.e. PPC) Component and Na Metal

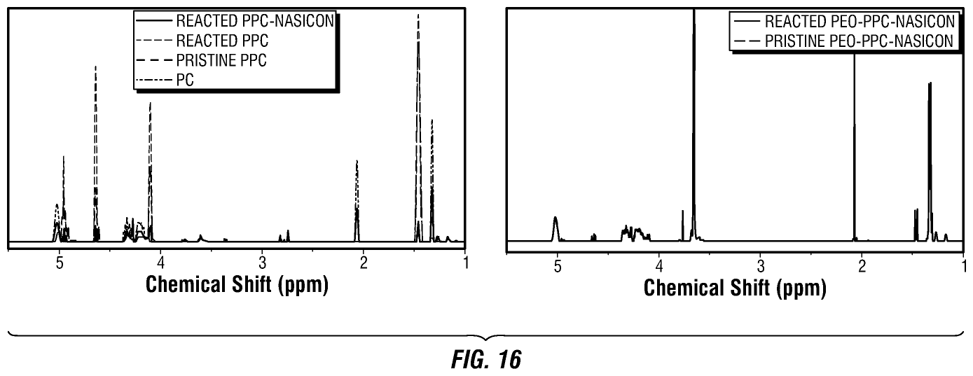

Nuclear magnetic resonance data (FIG. 16) reveals that the polyester polymer (i.e. PPC) can spontaneously react with Na metal: Na metal chemically scissors the polyester polymer (i.e. PPC) chain randomly and therefore forming a certain amount of PC monomers; meanwhile adding NASICON into PPC can mitigate the reaction to a certain extend. By blending in PEO polymer along with NASICON (PEO−PPC−NASICON) with the optimized ratio of 48 wt % polyether (i.e. PEO), 37 wt % polyester (i.e. PPC) and 15 wt % ceramic filler (i.e. NASICON), the random chain scission reaction with Na can be effectively minimized (FIG. 16, bottom). The reacted proposed solid-state polymer composite electrolyte (PEO−PPC−NASICON) and pristine PEO−PPC−NASICON exhibited nearly identical Nuclear magnetic resonance (FIG. 16, bottom), with the reacted sample showcasing an area under the curve that is 99% of the pristine sample, meaning that only 1% of the PEO−PPC−NASICON has been reacted by Na and this small amount of reacted monomer (PC) acts as a highly beneficial interfacial surface wetting agent to greatly improve the interfacial conductivity of the solid-state polymer composite electrolyte. Therefore, the proposed solid-state polymer composite electrolyte with the optimized recipe not only demonstrated the highest ionic conductivity reported to date but also effectively resolved the issue of reactivity of polyester (i.e. PPC) with Na.

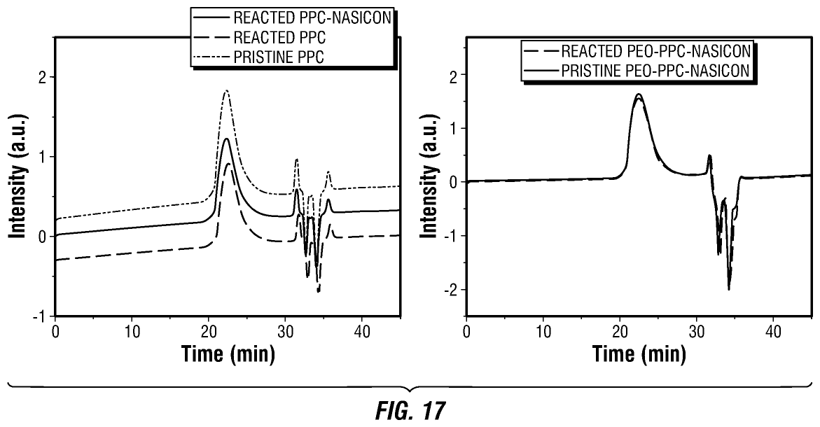

Gel permeation chromatography data (FIG. 17) reveals that the PPC polymer can spontaneously react with Na metal. Na metal chemically scissors the PPC polymer chain randomly and therefore forms a certain amount of PC monomers. Meanwhile, adding NASICON into PPC can mitigate the reaction to a certain extend.

The real solution comes in by blending in PEO polymer along with NASICON and PPC to form the proposed solid-state polymer composite electrolyte (PEO−PPC−NASICON). Given the optimized ratio of 48 wt % polyether (i.e. PEO), 37 wt % polyester (i.e. PPC) and 15 wt % ceramic filler (i.e. NASICON), the random chain scission reaction with Na can be effectively minimized (FIG. 17, right). Similar to the nuclear magnetic resonance discussed in FIG. 16, the reacted PEO−PPC−NASICON and pristine one exhibited nearly identical Nuclear magnetic resonance (FIG. 17, right), with the reacted sample showcased area under the curve is that 99% of the pristine sample, meaning that only 1% of the PEO−PPC−NASICON has been reacted by Na and this small amount of reacted monomer (PC) acts as a highly beneficial interfacial surface wetting agent to greatly improve the interfacial conductivity of the solid-state polymer composite electrolyte. Therefore, the proposed solid-state polymer composite electrolyte with the optimized recipe not only demonstrated the highest ionic conductivity reported to date and effectively resolved the issue of reactivity of polyester (i.e. PPC) with Na.

### Example 1.5. Systematic Electrochemical Performances Analysis on the Proposed Solid-State Polymer Composite Electrolyte with Optimized Recipe, and Verifying the Synergic Effects of PPC+PEO Mix for Superior Electrochemical Performance Far Better than Conventional PEO Solid Polymer Electrolyte

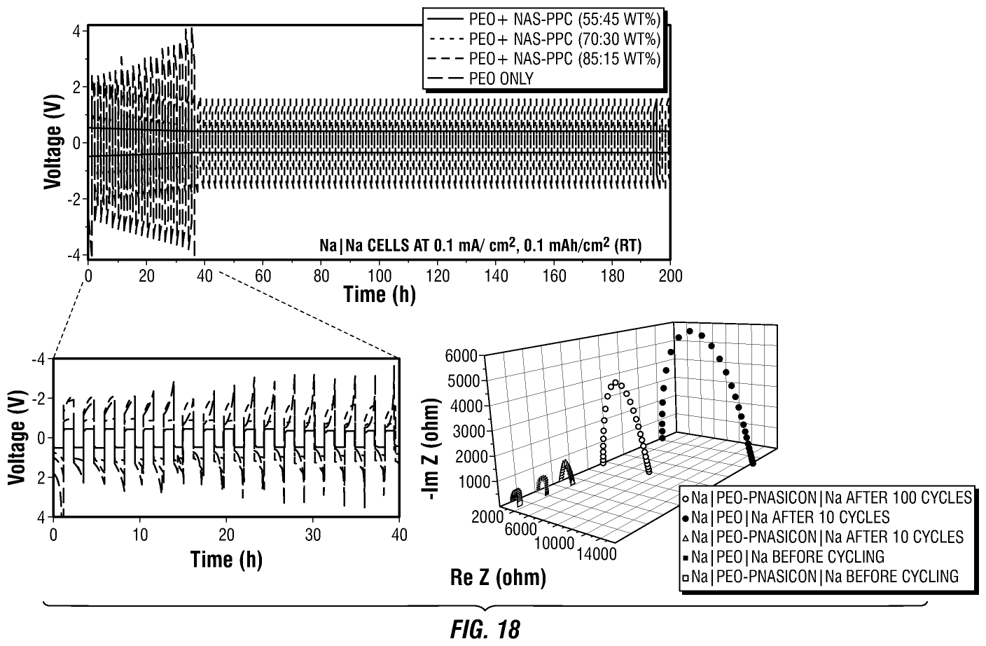

The electrochemical performance (FIG. 18) of the proposed solid polymer composite electrolyte (PEO+PPC+NASICON) when used in a half cell with Na metal being both working and counter electrodes. At a given current density and capacity, Na ions are being cycled between the two symmetrical Na electrodes through the proposed solid polymer composite electrolyte (PEO+PPC+NASICON). Then, the resulting cycling voltage overpotential is directly proportional to the ionic resistance and therefore electrochemical inefficiency, therefore the lower voltage represents the better electrochemical performance. From here, it can easily be observed that the optimized proposed solid polymer composite electrolyte (PEO+PPC+NASICON) delivered the lowest voltage overpotential at about 0.5 V, while PEO+PPC+NASICON with less optimized ratios showcased much higher voltage overpotential at 1 V and 2 V. Note that the conventional polyether polymer (i.e. PEO) exhibited an extremely large voltage overpotential number at 2 V and increasing, indicating the very poor electrochemical performance. Therefore, the proposed solid polymer composite electrolyte (PEO+PPC+NASICON) represents a quantum leap towards the next-generation safe solid-state battery. Additionally, the proposed solid polymer composite electrolyte (PEO+PPC+NASICON) shows 10 folds lower interfacial impedance before and after cycling with Na metal electrodes. These observations validated that the proposed solid polymer composite electrolyte (PEO+PPC+NASICON) remains highly chemically stable and electrochemically superior both before and after Na metal cycling, which is highly beneficial in enabling highly efficient Na metal batteries.

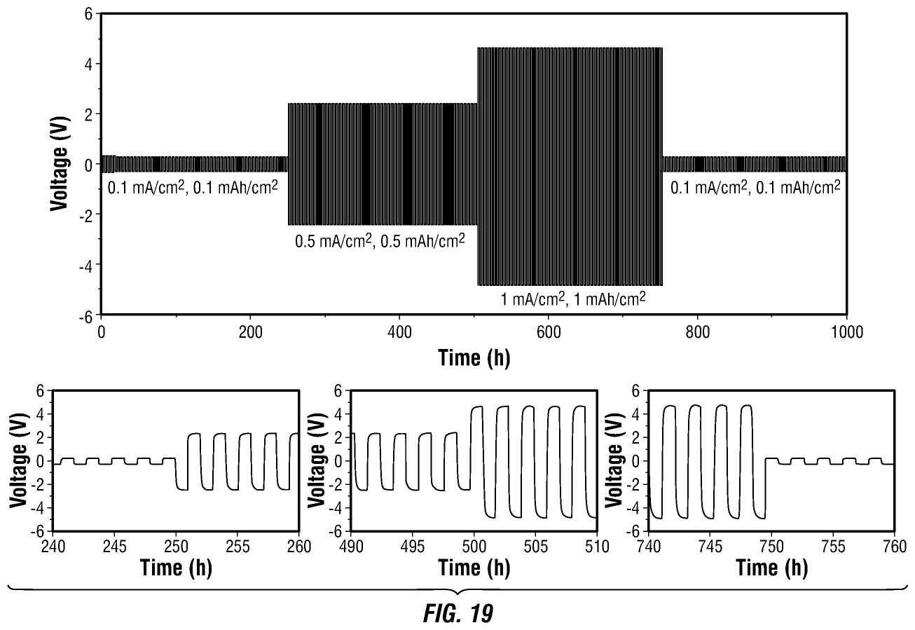

The electrochemical performance (FIG. 19) of the proposed solid polymer composite electrolyte (PEO+PPC+NASICON) when used in a half cell with Na metal in various current density and capacity conditions is demonstrated. It can be seen that PEO+PPC+NASICON delivered outstanding electrochemical performance for Na ion cycling at different current densities with extremely stable and low voltage overpotential profile. This is a sharp contrast compared to conventional PEO polymer electrolyte where it shows highly unstable and large voltage overpotential. This experiment demonstrates the PEO+PPC+NASICON can sustain very harsh electrochemical cycling conditions and able to maintain its good performance.

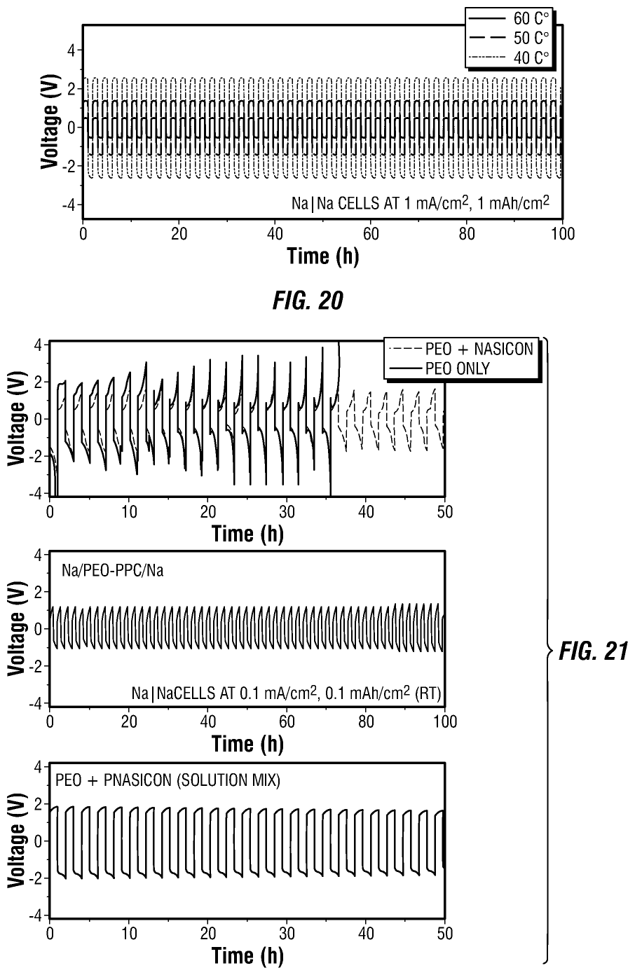

The electrochemical performance of the proposed solid polymer composite electrolyte (PEO+PPC+NASICON) when used in a half cell with Na metal in various temperature conditions is demonstrated in FIG. 20. Evidently, PEO+PPC+NASICON delivered consistently high electrochemical performance for Na ion cycling at different temperatures with extremely stable and low voltage overpotential profile.

The control experiments on electrochemical cycling of various polymer and ceramic combination with Na metal electrodes that yielded relatively mediocre electrochemical cycling performances compared to that of the proposed solid polymer composite electrolyte is demonstrated in FIG. 21. Here, the control experiments all showcased fluctuating and high voltage overpotential at 2 volt or more, compared to the significantly more stable voltage overpotential of the proposed solid-state polymer electrolyte with much lower overpotential at 0.5 volt.

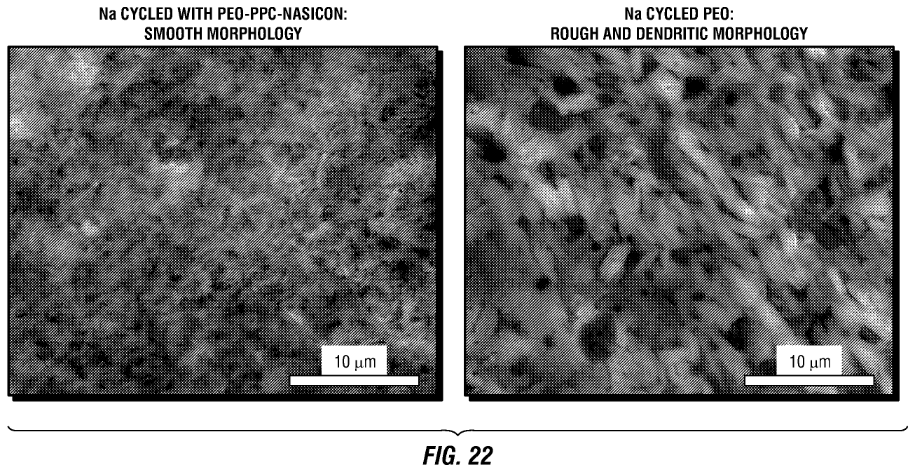

The scanning electron microscope imaging (FIG. 22) revealed the Na metal electrodes after cycling with the proposed solid polymer composite electrolyte (PEC+PPC+NASICON) and conventional polyether polymer (i.e. PEO). The imaging revealed that after-cycled Na metal electrodes exhibited very smooth and dendrite-free morphology, indicating the uniform and efficient plating and stripping of Na ions enabled by proposed solid polymer composite electrolyte. Meanwhile, the after-cycled Na metal electrodes with conventional solid polymer composite electrolyte exhibited very rough and dendrite morphology, indicating the non-uniform and inefficient plating and stripping of Na ions as a result of conventional solid polymer composite electrolyte. These empirical evidences very clearly demonstrated that the tremendous benefits of proposed PEC+PPC+NASICON that enables a safe and high efficient battery system by its capability to plate Na ions onto electrode surface uniformly, without causing rough and dendritic morphology. The metal dendrite growth during battery cycling is the main reason for battery short-circuit and therefore severe safety concern, and the proposed PEC+PPC+NASICON effectively solved this challenge.

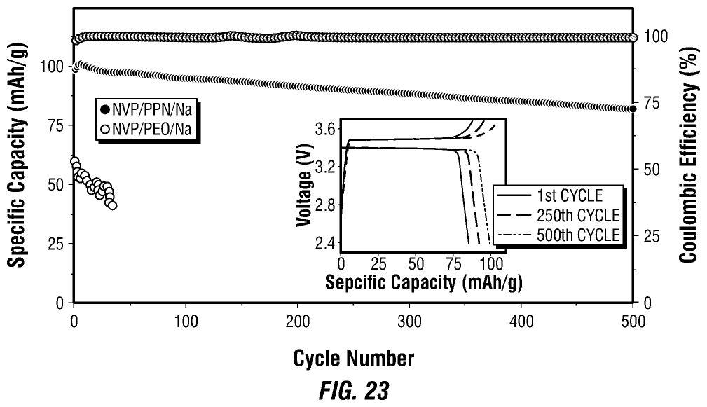

The electrochemical performance of proposed solid polymer composite electrolyte (PEO−PPC−NASICON) in a full battery with Na metal anode and Na₃V₂(PO₄)₃ cathode at 1C rate current density is demonstrated in FIG. 23. This is a test to evaluate the electrochemical performance of proposed PEO−PPC−NASICON with proposed solid polymer composite electrolyte. The Na metal full battery delivered far more superior performance in terms of capacity, cycling efficiency, cycling life and stable voltage profile. In sharp contrast, the Na metal battery with conventional solid polymer composite electrolyte delivered much more inferior performance under the same condition in every aspect, including specific capacity, cycling efficiency, voltage overpotential and more. Therefore, this full battery cycling test with the proposed PEO−PPC−NASICON thoroughly validated utility and functionality, enabling safe and high-performance Na metal batteries.

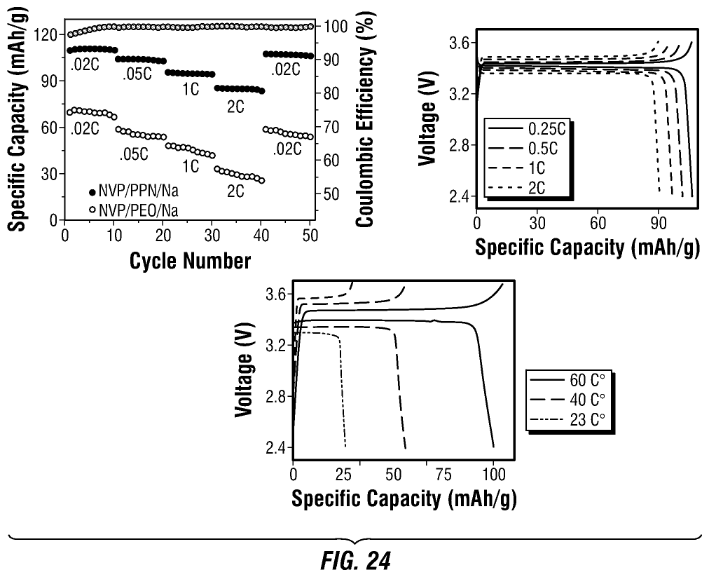

The electrochemical performance of proposed solid polymer composite electrolyte (PEO−PPC−NASICON) in a full battery with Na metal anode and Na₃V₂(PO₄)₃ cathode at various current density conditions is demonstrated in FIG. 24. The robustness of PEO−PPC−NASICON was confirmed through this test in which it managed to deliver dramatic cycling improvements compared to that of the control experiment with conventional polyether (i.e. PEO) electrolyte. Furthermore, PEO−PPC−NASICON was tested in a full battery configuration at various temperature conditions to illustrate that it can operate at extreme environmental conditions. In all these tests, the proposed PEO−PPC−NASICON delivered far more superior performance than conventional polymer electrolytes.

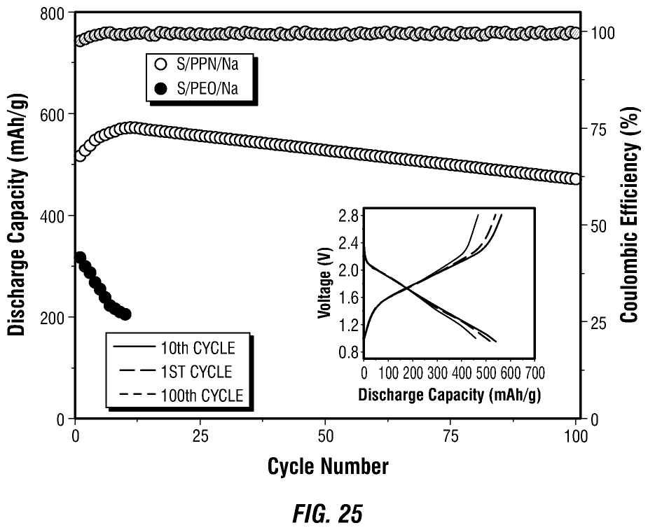

The proposed solid polymer composite electrolyte (PEO−PPC−NASICON) was put to subsequent electrochemical cycling tests (FIG. 25) with a Na metal anode and a sulfur cathode. The sodium-sulfur is widely regarded as the holy grail of next-generation battery chemistry that provides substantially higher energy than state-of-the-art lithium-ion batteries that is ubiquitous nowadays. PEO−PPC−NASICON enables a sodium-sulfur full battery with exceptional electrochemical performance, cycling efficiency and specific capacity. On the other hand, the control experiment with conventional polymer electrolyte with polyether polymer (i.e. PEO) has a much more inferior performance that is in sharp contrast with the proposed PEO−PPC−NASICON.

### Example 1.6. Experimental Procedures

Ceramic Electrolyte Preparation: Na₃Zr₂Si₂PO₁₂ NASICON solid electrolyte was synthesized through solid-state reaction combined with mechanochemical process. Stoichiometric ratio of ZrO₂ (Sigma-Aldrich, ≥99.9%), Na₂CO₃ (Sigma-Aldrich, ≥99.5%), SiO₂ (Sigma-Aldrich, ≥99%) and NH₄H₂PO₄ (Sigma-Aldrich, ≥98%) were mixed accordingly for solid-state reaction in a high energy ball mill (SPEX Sample Prep 8000 M Mixer) within zirconium oxide container for 2 h. To prevent overheating of the sample, ball milling was paused for 15 min at the end of every hour. Next, the ball milled NASICON precursor powder was calcinated at 950° C. for 8 h in open air, and subsequently ball milling again for 2 h. The grounded powder was then pressed into pellets with 12.7 mm diameter and 0.75 mm thickness under a pressure of 500 MPa, and sintered at 1200° C. for 12 h.

Solid Polymer Composite Electrolyte Preparation: mixing 37 wt % polyester, polypropylene carbonate (PPC) or polyethylene carbonate (PEC) (Sigma-Aldrich), with 48 wt % polyether polymer polyethylene glycol (PEO) by high energy ball milling for 2 h with 10 mins interval and 5 mins resting period. This step is completed in short time interval to avoid overheating. After solid-state mixing, highly homogenous mixture should be obtained. Then, blending another 15 wt % of NASICON ceramic electrolyte by high energy ball milling for 2 h, again with resting interval to prevent overheating.

Dissolve this homogenous mixture in acetonitrile (Sigma-Aldrich) with 1 g/10 ml solid to liquid ratio, then apply this to dr. blade coating with 20 micron thickness gap. Drying a vacuum oven for 12 hours to finally obtain an about 20 micron thick solid polymer composite electrolyte. After drying, the solid polymer composite electrolyte should be transferred into argon filled glovebox for storage, and it can be used as it is for battery assembly.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A non-aqueous electrolyte, wherein the non-aqueous electrolyte comprises:
a polymeric component comprising a polyester-based polymer and a polyether-based polymer; and
a ceramic component comprising inorganic materials.

2. The non-aqueous electrolyte of claim 1, wherein the polyester-based polymer is selected from the group consisting of polyglycolide, polyglycolic acid (PGA), polylactic acid (PLA), polycaprolactone (PCL), polyhydroxyalkanoate (PHA), polyhydroxybutyrate (PHB), polyethylene adipate (PEA), polybutylene succinate (PBS), polyethylene terephthalate (PET), polybutylene terephthalate (PBT), polytrimethylene terephthalate (PTT), polyethylene naphthalate (PEN), polypropylene carbonate (PPC), polyethylene carbonate (PEC), or combinations thereof.

3. The non-aqueous electrolyte of claim 1, wherein the polyester-based polymer is selected from the group consisting of polypropylene carbonate (PPC), polyethylene carbonate (PEC), or combinations thereof.

4. The non-aqueous electrolyte of claim 1, wherein the polyether-based polymer is selected from the group consisting of paraformaldehyde, polyethylene glycol (PEG), polypropylene glycol (PPG), polytetramethylene glycol (PTMG), polytetramethylene ether glycol (PTMEG), polyoxymethylene (POM), polyacetal, polyformaldehyde, polyethylene oxide (PEO), polyoxyethylene (POE), polypropylene oxide (PPDX), polyoxypropylene (POP), polytetrahydrofuran (PTHF), or combinations thereof.

5. (canceled)

6. The non-aqueous electrolyte of claim 1, wherein the weight percent of the polymeric component in the non-aqueous electrolyte is between 25 wt % to 50 wt %.

7. The non-aqueous electrolyte of claim 1, wherein the weight percent of the polymeric component in the non-aqueous electrolyte is between 50 wt % to 75 wt %.

8. The non-aqueous electrolyte of claim 1, wherein the inorganic materials comprise sodium super ionic conductors (NASICON), wherein NASICON comprises chemical formula of Na₁₊ₓZr₂SiₓP₃₋ₓO₁₂, where x is greater than zero and less than three.

9. (canceled)

10. The non-aqueous electrolyte of claim 8, wherein NASICON is Na₃Zr₂Si₂PO₁₂.

11. The non-aqueous electrolyte of claim 1, wherein the weight percent of the ceramic component in the non-aqueous electrolyte is between 0.1 wt % to 50 wt %.

12. (canceled)

13. The non-aqueous electrolyte of claim 1, wherein the weight ratio of the polymeric component to the ceramic component is 50:50, 75:25, or 85:15.

14-15. (canceled)

16. The non-aqueous electrolyte of claim 1, wherein the polymeric component comprises polyethylene oxide (PEO) and polypropylene carbonate (PPC), and wherein the ceramic component comprises sodium super ionic conductors (NASICON).

17. The non-aqueous electrolyte of claim 1, wherein the polymeric component and the ceramic component are combined through solid state mixing.

18. The non-aqueous electrolyte of claim 1, wherein the non-aqueous electrolyte is in the form of a solid-state electrolyte.

19. The non-aqueous electrolyte of claim 1, wherein the non-aqueous electrolyte is a component of an energy storage device comprising:
an anode;
a cathode; and
the non-aqueous electrolyte.

20. The non-aqueous electrolyte of claim 19, wherein the anode comprises a component selected from the group consisting of sodium, aluminum, zinc, magnesium, titanium, tin, cadmium, lead, copper, lithium, metal alloys, or combinations thereof, and wherein the cathode comprises a component selected from the group consisting of sodium, vanadium, phosphor, sulfur, aluminum, zinc, magnesium, titanium, tin, cadmium, lead, copper, lithium, metal alloys, or combinations thereof.

21. The non-aqueous electrolyte of claim 19, wherein the anode is a sodium-based anode.

22. (canceled)

23. The non-aqueous electrolyte of claim 19, wherein the cathode is a sodium-based cathode.

24. The non-aqueous electrolyte of claim 19, wherein the energy storage device is a battery.

25. The non-aqueous electrolyte of claim 19, wherein the energy storage device is a sodium-based battery.

26. The non-aqueous electrolyte of claim 25, wherein the sodium-based battery is selected from the group consisting of sodium metal batteries, sodium sulfur batteries, sodium-ion batteries, sodium-air batteries, sodium oxygen batteries, sodium-carbon dioxide batteries, sodium-sulfur metal batteries, sodium-containing metal batteries, or combinations thereof.

27-31. (canceled)
